(19) United States
(12) Patent Application Publication
(10) Pub. No.: US 2003/0197384 A1
(43) Pub. Date: Oct. 23, 2003

(54) Engine starting system

(75) Inventor: Carl Thomas Vuk, Denver, IA (US)

Correspondence Address: Joel S. Carter, Patent Department, DEERE & COMPANY, One John Deere Place, Moline, IL, 61265-8098, US

(73) Assignee: Deere & Company, a Delaware Corporation

(21) Appl. No.: 10/125,126

(22) Filed: Apr. 18, 2002

(51) Int. Cl. H02P 9/04; F02N 11/00

(52) U.S. Cl. 290/38 R

(57) ABSTRACT

A starting system is provided for an engine having a starting ring gear on the engine flywheel. The starting system includes an integrated starter generator having a rotor coupled to the flywheel, a starter motor having a drive gear which selectively engages the ring gear, and an electronic controller coupled to the starter motor and to the starter generator. The electronic controller activates only the starter generator when only low starting torque is required. The electronic controller activates both the starter generator and the starter motor when high starting torque is required.

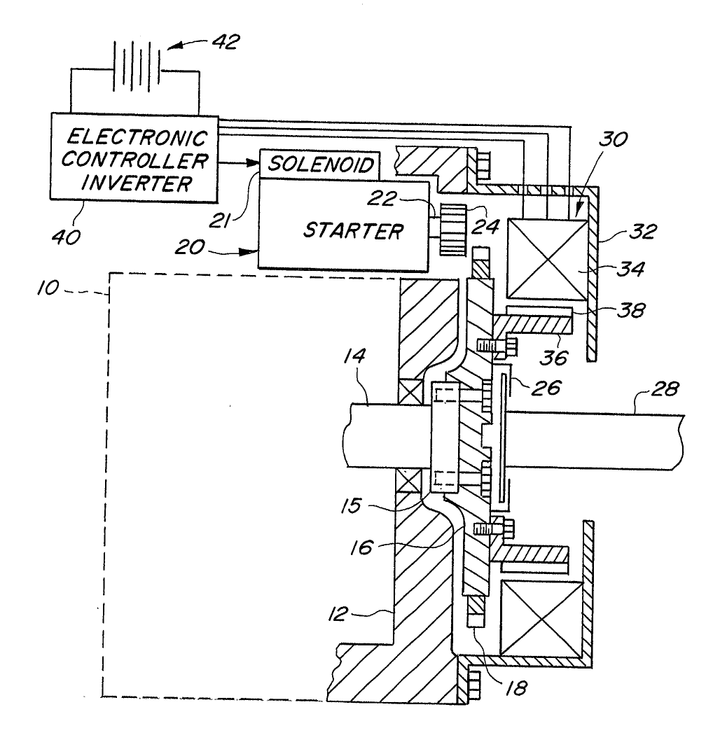

### BACKGROUND OF THE INVENTION

The present invention relates to an engine starting system.

Integrated starter generator systems have been used in aviation applications, and are beginning to be introduced in automotive applications. Heavy-duty vehicles, such as agricultural tractors have large starting torque requirements. If an integrated starter generator is used as the only source of starting torque in such applications, then the starter generator must have a power capacity sufficient to provide high starting torque. However, such a starter generator with such a high starting toque power capacity may result in compromised efficiency when it operates as a generator.

### SUMMARY

Accordingly, an object of this invention is to provide a starting system with an integrated starter generator for a heavy duty vehicle.

This and other objects are achieved by the present invention, which is a starting system for an engine having a starting ring gear on the engine flywheel. The starting system includes an integrated starter generator having a rotor coupled to the flywheel, a starter motor having a drive gear which selectively engages the ring gear, and an electronic controller coupled to the starter motor and to the starter generator. The electronic controller activates only the starter generator when only low starting torque is required. The electronic controller activates both the starter generator and the starter motor when high starting torque is required. As a result, the starter generator need not have a capacity to supply all of the required high starting torque.

### BRIEF DESCRIPTION OF THE DRAWING

The sole Figure is a sectional view and simplified schematic diagram of a starting system according to the present invention.

### DETAILED DESCRIPTION

Referring to the sole Figure, an engine 10 includes an engine block housing 12 and a rotatable crankshaft 14. A conventional flywheel 16 is attached, such as by bolts, to a flange 15 mounted on an end of the crankshaft 14. A starting ring gear 18 is mounted on the outer periphery of the flywheel 16, such as heat fitting over the cold flywheel. A conventional starter motor 20 is mounted on the engine. Starter motor 20 has a solenoid 21 and an output shaft 22 on which is fixed a pinion gear 24. Starter motor 20 may have various voltage capabilities, such as 12 or 42 volts. Pinion gear 24 is axially movable to meshingly engage with ring gear 18. A clutch 26 couples the flywheel 16 to an output shaft 28.

An integrated starter generator 30, such as made by Bosch, is mounted in a bell housing 32 which is bolted to the engine block 12. Starter generator 30 includes a stator 34 which is secured to the housing 32 and a rotor 36 (with magnets 38) which is bolted to the flywheel 16. Starter generator 30 is electrically connected to an electronic controller/converter 40, which in turn is connected to a battery 42, such as a 42 volt battery. Starter motor 20 is also electrically connected to electronic controller/converter 40.

During engine starting operations, the controller/converter 40 causes starter generator 30 to rotate the engine flywheel 16. The controller/converter 40 also determines engine cranking speed from signals supplied from the starter generator 30. If the cranking speed is less than a desired minimum cranking speed, then controller/converter 40 also energizes starter motor 20 and the solenoid 21 to provide additional starting torque by causing gear 24 to engage and rotate ring gear 18. Thus, the integrated starter generator 30 will start the engine 10 during conditions when low starting torque is required.

Starter generator 30 can also be used to run up the engine speed after the starting motor 20 has been operated and then disengaged. The speed at which the starting motor 20 disengages can be adjusted, and is preferably in a 100 to 300 rpm range.

If sufficiently high starting torque is required, the starter generator 30 together with starter motor 20 will provide such a high starting torque. As a result, the starter generator 30 need not have a large power capacity for high starting toque situations, and such a smaller capacity starter generator will be more efficient than a larger starter generator when operating as a generator.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A starting system for an engine having a flywheel and a starting ring gear mounted on the flywheel, the starting system comprising:
a starter generator having a rotor coupled to the flywheel;
a starter motor having a drive gear which selectively engages the ring gear; and
an electronic controller coupled to the starter motor and to the starter generator, the electronic controller activating only the starter generator during low starting torque conditions and the electronic controller activating both the starter motor and the starter generator during high starting torque conditions.

2. The starting system of claim 1, wherein:
the electronic controller determines an engine cranking speed from signals received from the starter generator.

3. The starting system of claim 1, wherein:
if the cranking speed is less than a desired minimum cranking speed, the electronic controller energizes the starter generator and the starter motor.

4. The starting system of claim 1, wherein:
the electronic controller activates the starter motor and then the starter generator sequentially, one after the other.
